(19) United States
(12) Patent Application Publication
(10) Pub. No.: US 2011/0115599 A1
(43) Pub. Date: May 19, 2011

(54) WINDING INDUCTOR AND PROCESS FOR MANUFACTURING THE SAME

(75) Inventors: Etsuo Otsuki, Tokyo (JP); Ayako Kaneda, Tokyo (JP)

(73) Assignee: TOHO ZINC CO., LTD., CHUO-KU TOKYO (JP)

(21) Appl. No.: 12/597,563

(22) PCT Filed: Apr. 25, 2008
(86) PCT No.: PCT/JP2008/058025

§ 371 Date: Nov. 18, 2010

(30) Foreign Application Priority Data
Apr. 26, 2007 (JP) 2007-116411

(51) Int. Cl. H01F 17/04; H01F 27/28; H01F 41/06

(52) U.S. Cl. 336/221; 29/605

(57) ABSTRACT

The present invention provides an inductor having high DC bias characteristics using a Fe alloy core and provides a method for manufacturing the same. The present invention relates to a wire-wound inductor which includes: a wire-wound inductor core obtained by grinding a compression molded mixed magnetic material powder including magnetic substance powder mixed with binder; and a metal conductive wire wound around a groove section of the wire-wound inductor core. For example, the magnetic substance powder has content ratio of 4 to 13 wt % of Si; 4 to 7 wt % of Al; the balance Fe; and unavoidable impurity. The magnetic substance powder has particle diameter distribution in which equal to or greater than 90% of the magnetic substance powder has particle diameter equal to or lower than 75 μm.

### TECHNICAL FIELD

The present invention relates to a wire-wound inductor using an Fe alloy core and to a method for manufacturing the wire-wound inductor. In particular, the present invention relates to a method for manufacturing a wire-wound inductor using a superior core having fewer chipping and cracking, and relates to a wire-wound inductor having superior DC bias characteristics.

### BACKGROUND ART

Recently, power source circuits of micro electronic devices such as mobile phones and computers etc. use many chip inductors. Many conventional chip inductors use ferrite cores since ferrite is capable of becoming a closely-grained sintered body. That is, the ferrite core made from closely-grained sintered body and susceptible to grinding operation is invulnerable to chipping or cracking, which will be a main cause of magnetic resistance, formed on a flange part.

In one problem, high amperage current used in an increasing number of micro electronic devices causes rapid drop of inductance, which may cause explosion of the power source circuit. Therefore, demand is increasing for inductors usable in power source circuit and having a greater saturation magnetization and superior DC bias characteristics.

However, inductors using ferrite cores could by no means withstand high amperage current since DC bias characteristics and saturation magnetization of were not so superior.

In another attempt of manufacturing a core usable in an inductor and made from Fe alloy magnetic substance powder having superior in DC bias characteristics, it was difficult to manufacture a core using Fe alloy since a process for grinding a molded component to manufacture the core experiences chipping, cracking, or fracture on its flange parts due to its hardness or particle size.

### [Patent Document 1] Japanese Patent Laid-open Publication No. 2000-012345

### DISCLOSURE OF THE INVENTION

### Problems to be Solved by the Invention

The present invention relates to a novel Fe alloy core having fewer chipping and cracking on its flange parts and having no fracture of a central groove, and an object thereof is to provide a wire-wound inductor having superior DC bias characteristics attributed by a higher saturation magnetization than that of a sintered ferrite inductor.

### Means for Solving Problem

As a means for solving the aforementioned problem, the invention according to claim 1 is a wire-wound inductor which includes a wire-wound inductor core made of a pressed body obtained by compression-molding mixed magnetic material powder including magnetic substance powder mixed with binder, the wire-wound inductor core having a groove section formed therearound; and a metal conductive wire wound around the groove section of the wire-wound inductor core, and is characterized in that the magnetic substance powder has content ratio of 4 to 13 wt % of Si, 4 to 7 wt % of Al, the balance Fe, and unavoidable impurity, and the magnetic substance powder has particle diameter distribution in which equal to or greater than 90% of the magnetic substance powder has particle diameter equal to or lower than 75 μm.

The invention according to claim 2 is a wire-wound inductor which includes a wire-wound inductor core made of a pressed body obtained by compression-molding mixed magnetic material powder including magnetic substance powder mixed with binder, the wire-wound inductor core having a groove section formed therearound; and a metal conductive wire wound around the groove section of the wire-wound inductor core, and is characterized in that the magnetic substance powder has content ratio of 4 to 18 wt % of Si, 15 to 20 wt % of B, the balance Fe, and unavoidable impurity, and the magnetic substance powder has particle diameter distribution in which equal to or greater than 85% of the magnetic substance powder has particle diameter equal to or lower than 75 μm.

The invention according to claim 3 is a wire-wound inductor which includes a wire-wound inductor core made of a pressed body obtained by compression-molding mixed magnetic material powder including magnetic substance powder mixed with binder, the wire-wound inductor core having a groove section formed therearound; and a metal conductive wire wound around the groove section of the wire-wound inductor core, and is characterized in that the magnetic substance powder has content ratio of 4 to 8 wt % of Si, the balance Fe, and unavoidable impurity, and the magnetic substance powder has particle diameter distribution in which equal to or greater than 80% of the magnetic substance powder has particle diameter equal to or lower than 45 μm.

The invention according to claim 4 is the wire-wound inductor as claimed in one of claims 1 to 3, and is characterized in that the wire-wound inductor core has a round column shape or a polygonal column shape.

The invention according to claim 5 is the wire-wound inductor as claimed in one of claims 1 to 4, and is characterized in that the groove section formed on the wire-wound inductor core has a depth which is equal to or greater than ⅔ of a width of the wire-wound inductor core.

The invention according to claim 6 is the wire-wound inductor as claimed in one of claims 1 to 5, and is characterized in that the magnetic substance powder is obtained by metal comminution or atomization.

The invention according to claim 7 is the wire-wound inductor as claimed in one of claims 1 to 6, and is characterized in that the binder is added by equal to or lower than 5 wt %.

The invention according to claim 8 is a method for manufacturing a wire-wound inductance which includes the steps of: manufacturing a wire-wound inductor core; and winding a metal conductive wire around the wire-wound inductor core, and is characterized in that the step of manufacturing the wire-wound inductor core includes a step including steps of: manufacturing the magnetic substance powder having content ratio of 4 to 13 wt % of Si, 4 to 7 wt % of Al, the balance Fe, and unavoidable impurity; limiting particle diameter of the magnetic substance powder; adding binder to the magnetic substance powder; compressing the magnetic substance powder, to which the binder was added, to form a pressed body; and grinding the pressed body by machine, and is characterized in that, in the step for limiting the particle diameter, the magnetic substance powder has particle diameter distribution in which equal to or greater than 90% of the magnetic substance powder is limited to particle diameter equal to or lower than 75 μm.

The invention according to claim 9 is a method for manufacturing a wire-wound inductance, which includes the steps of: manufacturing a wire-wound inductor core; and winding a metal conductive wire around the wire-wound inductor core, and is characterized in that, the step of manufacturing the wire-wound inductor core includes a step including steps of: manufacturing the magnetic substance powder having content ratio of 4 to 18 wt % of Si, 15 to 20 wt % of B, the balance Fe, and unavoidable impurity; limiting particle diameter of the magnetic substance powder; adding binder to the magnetic substance powder; compressing the magnetic substance powder, to which the binder was added, to form a pressed body; and grinding the pressed body by machine, and is characterized in that, in the step for limiting the particle diameter, the magnetic substance powder has particle diameter distribution in which equal to or greater than 85% of the magnetic substance powder is limited to particle diameter equal to or lower than 75 μm.

The invention according to claim 10 is a method for manufacturing a wire-wound inductance, which includes the steps of manufacturing a wire-wound inductor core; and winding a metal conductive wire around the wire-wound inductor core, and is characterized in that the step of manufacturing the wire-wound inductor core includes a step including steps of: manufacturing the magnetic substance powder having content ratio of 4 to 8 wt % of Si, the balance Fe, and unavoidable impurity; limiting particle diameter of the magnetic substance powder; adding binder to the magnetic substance powder; compressing the magnetic substance powder, to which the binder was added, to form a pressed body; and grinding the pressed body by machine, and is characterized in that, in the step for limiting the particle diameter, the magnetic substance powder has particle diameter distribution in which equal to or greater than 80% of the magnetic substance powder is limited to particle diameter equal to or lower than 45 μm.

The invention according to claim 11 is the method as claimed in one of claims 8 to 10 for manufacturing the wire-wound inductor, characterized in that a shape of the pressed body formed in the compressing step is a round column shape or a polygonal column shape.

The invention according to claim 12 is the method as claimed in one of claims 8 to 11 for manufacturing the wire-wound inductor, characterized in that, in the grinding step, equal to or greater than ⅔ is ground with respect to the width of the pressed body.

The invention according to claim 13 is the method as claimed in one of claims 8 to 12 for manufacturing the wire-wound inductor, characterized in that, in the step for manufacturing the magnetic substance powder, the magnetic substance powder is manufactured by metal comminution of alloy or atomization of alloy.

The invention according to claim 14 is the method as claimed in one of claims 8 to 13 for manufacturing the wire-wound inductor, characterized in that, in the adding step, the binder is added by equal to or lower than 5 wt %.

### EFFECT OF THE INVENTION

The present invention can provide a wire-wound inductor using a wire-wound inductor core which has fewer chipping and cracking on its flange parts made from Fe alloy and has a greater saturation magnetization and having a superior DC bias characteristics. The present invention can provide a method for manufacturing the wire-wound inductor.

### BRIEF DESCRIPTION OF DRAWINGS

FIG. 1 is a perspective overview of a wire-wound inductor according to one embodiment.

FIG. 2 shows a process of manufacturing the wire-wound inductor of the embodiment.

FIG. 3 shows the surface of a core 1A of an example 1 observed by using a field emission scanning electron microscope.

FIG. 4 shows the surface of a comparison example core 1D, which will be explained with reference to the example 1, observed by using a field emission scanning electron microscope.

FIG. 5 shows profiles of DC bias characteristics obtained in the example 1 and in a comparison example.

FIG. 6 shows profiles of DC bias characteristics obtained in an example 2 and in a comparison example.

FIG. 7 shows profiles of DC bias characteristics obtained in an example 3 and in a comparison example.

FIG. 8 shows profiles of DC bias characteristics obtained in an example 4 and in a comparison example.

FIG. 9 shows profiles of DC bias characteristics obtained in an example 5 and in a comparison example.

FIG. 10 shows profiles of DC bias characteristics obtained in an example 6 and in a comparison example.

FIG. 11 shows profiles of DC bias characteristics obtained in an example 7 and in a comparison example.

### EXPLANATION OF REFERENCE

1: wire-wound inductor
2: wire-wound inductor core
3: metal conductive wire
4: groove section
10: magnetic substance powder
11: binder
12: alloy
13: sieve
14: mixed magnetic material powder
15: pressed body
16: single-screw press
17: diamond cutter
18: rotating member
20: magnetic substance powder
30: magnetic substance powder

### BEST MODE FOR CARRYING OUT THE INVENTION

An Embodiment of the present invention will be explained in detail with reference to the accompanying drawings. The same constituents in the explanation will be designated by the same reference numerals, and duplicate explanations will be omitted.

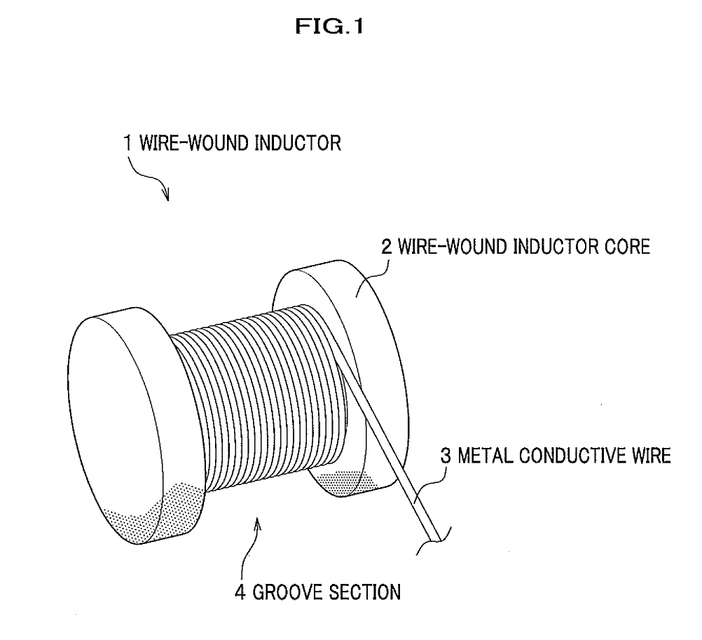

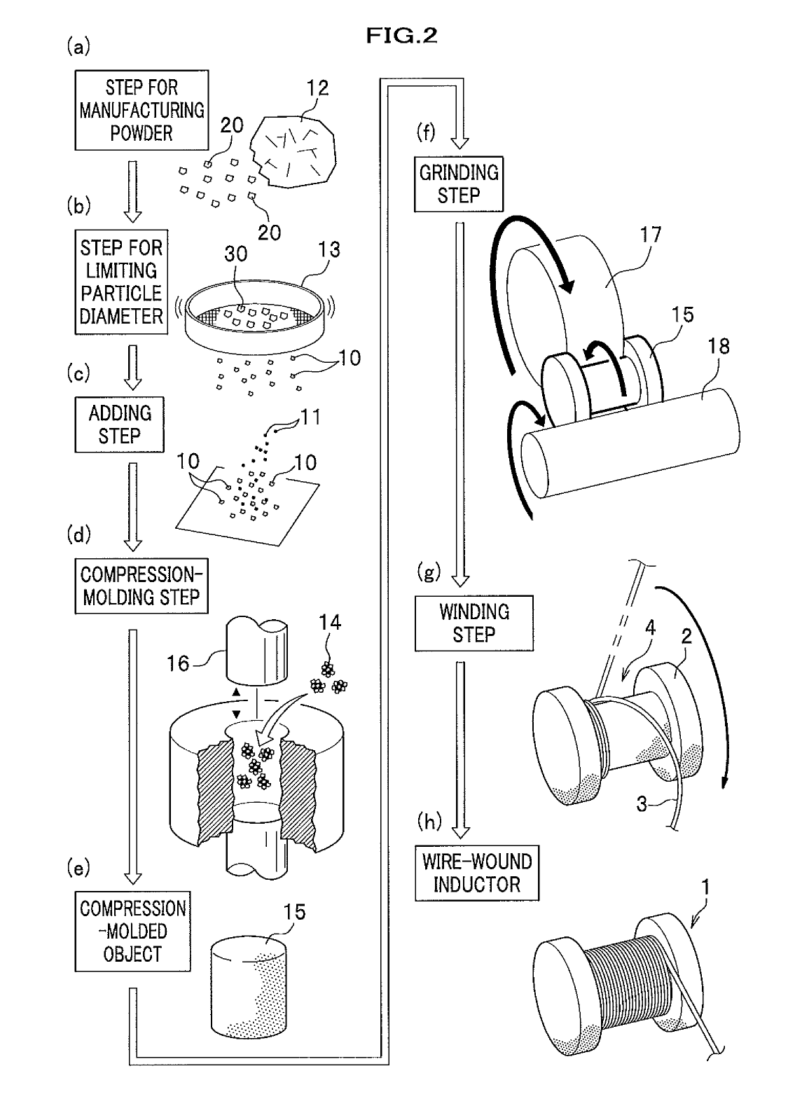

FIG. 1 is a perspective overview of a wire-wound inductor according to one embodiment of the present invention. FIG. 2 shows a process of manufacturing the wire-wound inductor of the embodiment of the present invention. More specifically, FIG. 2(a) shows a process of manufacturing powder. FIG. 2(b) shows a process of limiting the particle diameter of magnetic substance powder. FIG. 2(c) shows a process of adding binder. FIG. 2(d) shows a compression-molding process. FIG. 2(e) is a perspective view of a pressed body molded in the compression-molding process. FIG. 2(f) shows a process of grinding. FIG. 2(g) shows a coil-winding process. FIG. 2(h) is a perspective view of a finished wire-wound inductor. Hereinafter, the present invention will be explained more specifically.

### (Wire-Wound Inductor)

FIG. 1 is a perspective view of a wire-wound inductor 1 according to one embodiment of the present invention. It should be noted that the present invention is not limited to the wire-wound inductor 1 having a columnar shape as shown in FIG. 1, and the present invention may be a polygonal column wire-wound inductor. A wire-wound inductor core 2 and a metal conductive wire 3 constitute the wire-wound inductor 1. The wire-wound inductor core 2 has a groove section 4 formed thereon. The metal conductive wire 3 is wound around the groove section 4. Electromagnetic induction caused by electric current passing through the metal conductive wire 3 creates a magnetic field in the wire-wound inductor core 2.

### Wire-Wound Inductor Core

Material used for manufacturing the wire-wound inductor core 2 are magnetic substance powder 10 and binder 11. The wire-wound inductor core 2 can be manufactured by: adding binder 11 having 5 wt % or lower to the magnetic substance powder 10; stirring it to a sufficient degree to obtain mixed magnetic material powder 14; compressing the mixed magnetic material powder 14 to obtain a pressed body 15; and grinding the pressed body 15. The materials used and the manufacturing process will be explained later in details.

The shape of the wire-wound inductor core 2 is not limited to the columnar shape as shown in FIG. 1 and may be a polygonal column. However, the polygonal column may be vulnerable to chipping especially on its corners. Therefore, if the magnetic substance powder 10 is Fe—Si—Al alloy powder or Fe—B—Si-amorphous powder, it is preferable that the content ratio of magnetic substance powder 10 having particle diameter of 75 μm or lower should be greater in a polygonal column wire-wound inductor core 2.

The wire-wound inductor core 2 has the groove section 4 around which the metal conductive wire 3 is wound. The groove section 4 is manufactured by machine-grinding the pressed body 15. Width and depth for grinding the pressed body 15 are not limited specifically and are adjustable if necessary in view of usage.

In addition, it is preferable that the ratio of depth of the groove section 4 should be smaller with respect to the width of the wire-wound inductor core 2 since flange parts etc. of the wire-wound inductor core 2 become invulnerable to chipping or cracking in mechanical grinding.

### (Magnetic Substance Powder)

The wire-wound inductor core 2 is made from the magnetic substance powder 10 which is Fe—Si—Al alloy powder, Fe—B—Si-amorphous powder, or Fe—Si alloy powder.

In view of DC bias characteristics, the aforementioned Fe—Si—Al alloy powder consists of: 4 to 13 wt % of Si; 4 to 7 wt % of Al; and the balance Fe.

The particle diameter of the Fe—Si—Al alloy powder should be at least 75 μm or lower since the flange parts of the wire-wound inductor core 2 is vulnerable to cracking or chipping when grinding the groove on the wire-wound inductor core if the wire-wound inductor core includes Fe—Si—Al alloy powder having particle diameter equal to or greater than 75 μm.

Fe—B—Si-amorphous powder consists of: 4 to 18 wt % of Si; 15 to 20 wt % of B; and the balance Fe if used as the magnetic substance powder 10 in view of DC bias characteristics.

The particle diameter of the Fe—B—Si-amorphous powder should be at least 75 μm or lower.

Fe—Si alloy powder consists of 4 to 18 wt % of Fe; 15 to 20 wt % of Si; and the balance Fe if used as the magnetic substance powder 10 in view of DC bias characteristics.

The particle diameter of the Fe—Si alloy powder should be at least 45 μm or lower.

The magnetic substance powder 10, explained with reference to the Fe—Si—Al alloy powder etc. is obtained by: heating and melting materials including Fe, Si, and Al etc. to obtain an alloy 12; pulverizing the alloy 12; and limiting the diameter of the pulverized alloy 12 at, for example, 75 μm or lower by using a sieve etc.

The method for pulverizing the alloy 12 is not limited to machine comminution or atomization.

### (Binder)

The binder 11 binds the particles of the magnetic substance powder 10 when compression-molding the magnetic substance powder 10 to obtain the pressed body 15 by adding the binder 11 to the magnetic substance powder 10 and compression-molding it. Accordingly, the binder 11 is not limited to a specific type, and may be Silicon resin, water glass, epoxy resin, polyimide resin, paraffin, polyvinyl alcohol; or modified form, copolymer, or mixture of them.

In addition, it is preferable that the binder 11 having 5 wt % or lower should be added to the magnetic substance powder 10 since magnetic property will be deteriorated if the binder 11 is 5 wt % or higher.

### (Metal Conductive Wire)

The metal conductive wire 3 e.g. enamel-coated copper wire is not limited to a specific type in terms of shape, material, or diameter thereof.

### (Method for Manufacturing Wire-Wound Inductor)

Hereinafter, the method for manufacturing the wire-wound inductor 1 will be explained with reference to FIG. 2.

The magnetic substance powder 10 obtained by using a sieve etc. and having limited particle diameters will be explained separately from: magnetic substance powder 20 obtained by pulverizing an alloy; and magnetic substance powder 30 remaining on the sieve.

### (Step for Manufacturing Magnetic Substance Powder)

FIG. 2(a) shows an example of a step for manufacturing the magnetic substance powder 20. The step shown in FIG. 2(a) produces the magnetic substance powder 20 by crushing the alloy 12 by machine. The method used here for manufacturing the magnetic substance powder 20 from the alloy 12 is not limited to metal comminution. In the present invention, atomization is usable. The machine comminution may be performed in two steps including a step of coarse grinding using a jaw crusher and a step of fine grinding using a ball mill performed to the aforementioned coarsely ground alloy.

If the alloy 12 is the Fe—Si—Al alloy powder or the Fe—B—Si-amorphous powder, the particle diameter of the magnetic substance powder 20 produced in this step must be 75 μm or lower. If the alloy 12 is the Fe—Si alloy powder, the particle diameter of the magnetic substance powder 20 produced in this step must be 45 μm or lower because a limiting step which will be performed next cannot obtain magnetic substance powder 10 having the aforementioned particle diameter if the particle diameter of the magnetic substance powder 20 is equal to or greater than the aforementioned particle diameter; therefore, the wire-wound inductor core 2 having fewer chipping or cracking on its flange parts etc. cannot be manufactured.

On the other hand, the particle diameter of every pulverized magnetic substance powder 20 does not have to be the aforementioned particle diameter or lower since the magnetic substance powder 30 having particle diameter equal to or greater than the aforementioned particle diameter can be eliminated in a next limiting step.

The particle diameter of the produced magnetic substance powder 20 is reduced more uniformly if the time for crushing the magnetic substance powder 20 is extended. So a next limiting spep can be omitted if the particle diameter of every pulverized magnetic substance powder 20 is equal to or lower than required for manufacturing the wire-wound inductor core 2.

### (Step for Limiting Particle Diameter of Magnetic Substance Powder)

FIG. 2(b) shows an example of a step for limiting the particle diameter of the magnetic substance powder 20. In this step, the particle diameter of the magnetic substance powder 10 used for manufacturing the wire-wound inductor core 2 is limited to or lower than, for example, 75 μm by sieving the magnetic substance powder 20. The wire-wound inductor core 2 invulnerable to cracking or chipping can be manufactured by limiting the particle diameter of the magnetic substance powder 10 to or lower than a fixed particle diameter. Therefore, this step is not limited to particle sizing technique using a sieve 13 as exemplified in FIG. 2(b) as long as the particle diameter of the magnetic substance powder 10 can be limited.

The sieve 13 prepared for the particle sizing should have an opening or a mesh which is identical with the particle diameter of the magnetic substance powder 10. It is possible to select the particle diameter of the magnetic substance powder 10 for manufacturing the wire-wound inductor core 2 by limiting the size of the opening of the sieve 13.

The magnetic substance powder 20 is put into the sieve 13, and then the magnetic substance powder 20 having the particle diameter equal to or lower than the opening of the sieve 13 falls beneath the sieve 13; thereby the magnetic substance powder 10 is obtained.

If the magnetic substance powder 20 is Fe—Si—Al alloy powder or Fe—B—Si-amorphous powder, the opening or the mesh of the sieve 13 must be 75 μm. If the magnetic substance powder 20 is Fe—Si alloy powder, the opening or the mesh of the sieve 13 must be 45 μm.

On the other hand, the magnetic substance powder 30, having particle diameter equal to or greater than the opening of the sieve 13 and existing in the sieve 13, may be added to the magnetic substance powder 10 used for manufacturing the wire-wound inductor core 2. If the material of the magnetic substance powder 10, to which the magnetic substance powder 30 is added, is Fe—Si—Al alloy powder, the content ratio of the magnetic substance powder 10 having particle diameter equal to or lower than 75 μm must be 90% or greater. If the magnetic substance powder 10 is Fe—B—Si-amorphous powder, the content ratio of the magnetic substance powder 10 having particle diameters equal to or lower than 75 μm must be 85% or greater. If the magnetic substance powder 10 is Fe—Si alloy powder, the content ratio of the magnetic substance powder 10 having particle diameter equal to or lower than 45 μm must be at least 80%.

As previously explained, this step can be omitted if every produced magnetic substance powder 20 has a particle diameter equal to or lower than a fixed particle diameter by extending the time for crushing the magnetic substance powder 20.

### (Step for Adding Binder)

FIG. 2(c) shows an example of a step for adding the binder 11 to the magnetic substance powder 10. As explained above, it is preferable to add the binder 11 having 5 mass % or lower to the magnetic substance powder 10. In addition, the magnetic substance powder 10 to which the binder 11 has been added must be stirred and mixed sufficiently by using an agitation device. Hereinafter, the binder 11 added to and stirred with the magnetic substance powder 10 is referred to a mixed magnetic material 14.

### (Step for Compression-Molding Mixed Magnetic Material and Obtaining Pressed Body)

FIG. 2(d) shows an example of a step for compression-molding the mixed magnetic material 14 and obtaining a pressed body 15. In this step, the compressing force may be 1000 MPa or greater for compressing the mixed magnetic material 14. In this step, the mixed magnetic material 14 is put into a mold for manufacturing the columnar wire-wound inductor core 2, and then compressed by using a single-screw press 16 etc. Accordingly, the pressed body 15 shown in FIG. 2(e) is manufactured. Alternatively, a polygonal column pressed body 15 as a material for manufacturing a polygonal column core can be obtained by putting the mixed magnetic material 14 into a mold having a polygonal hole, and then compressing the mixed magnetic material 14 by using a compressing member having the equivalent shape to the polygonal hole.

### (Step for Grinding Pressed Body by Machine)

FIG. 2(e) shows an example of a step for grinding pressed body 15 by machine. In this step, the groove section 4 around which the metal conductive wire 3 is wound is formed on the pressed body 15. A diamond cutter 17 can be designated as a grinding wheel usable here. More specifically, in one method for preparing a columnar pressed body 15, a pressed body 16 is disposed between the diamond cutter 17 joining a rotational power source such as a motor etc. and a freely rotatable rotating member 18, and then the pressed body 15 is ground by rotating the diamond cutter 17. The pressed body is vulnerable to cracking or chipping in proportion with the rotation speed of the diamond cutter 17. For avoiding cracking and chipping, the rotation speed of the diamond cutter 17 should be as low as possible.

More specifically, a practical range of the grinding speed for effectively forming the groove section 4 around the pressed body 15 is 0.2 mm/sec. or higher. Sometimes, the grinding speed faster than 0.2 mm/sec. may be used for enhanced production efficiency. If the magnetic substance powder 10 is, for example, Fe—Si—Al alloy powder, it is preferable to manufacture the pressed body 15 by using the magnetic substance powder 10 having particle diameter equal to or lower than 50 μm in place of particle diameter equal to or lower than 75 μm, since the present invention must be capable of manufacturing the wire-wound inductor core 2 without lowering production efficiency.

It should be noted that the present invention is not limited to use the grinding speed equal to or faster than 0.2 mm/sec. Needless to say, the present invention can reduce the probability of cracking or chipping if the grinding speed is equal to or lower than 0.2 mm/sec.

### (Step for Winding Metal Conductive Wire Around Wire-Wound Inductor Core)

FIG. 2(g) shows a step for winding the metal conductive wire 3 around the wire-wound inductor core 2. The wire-wound inductor 1 shown in FIG. 2(h) is produced by fixing an end of the metal conductive wire 3; and turning the other end around the groove section 4 of the wire-wound inductor core 2 by predetermined times.

The present invention is not limited to the embodiment explained above.

### Example 1

(1-1)

A wire-wound inductor core according to an example 1 will be explained.

### (Preparation of Magnetic Substance Powder)

The example 1 used Fe—Si—Al alloy powder as the magnetic substance powder. The magnetic substance powder was obtained by heating and melting materials including Fe, Si, and Al to obtain an alloy; coarse grinding the obtained alloy by using a jaw crusher; and fine grinding the coarsely ground alloy by using a ball mill for 90 minutes. In the Fe—Si—Al alloy powder, the content ratio of Fe:Si:Al is 85:9.5:5.5.

### (Limiting Particle Diameter of Magnetic Substance Powder)

The particle diameter of each particle of the Fe—Si—Al alloy powder was limited to 75 μm or lower (hereinafter called magnetic substance powder 1A) by sieving the Fe—Si—Al alloy powder through a sieve having an opening of 75 μm. In addition, magnetic substance powder 1B was prepared by fine grinding the Fe—Si—Al alloy powder by using a ball mill for 180 minutes in place of performing the aforementioned step of limiting the particle diameter by using a sieve.

### (Limiting Particle Diameter of Comparison Example Magnetic Substance Powder)

Comparison example magnetic substance powder 1C and comparison example magnetic substance powder 1D were prepared by using a particle-diameter-limiting method that is different from the method for limiting the particle diameter of the magnetic substance powder 1A. The particle diameter of the magnetic substance powder 1C was limited by using a sieve having an opening of 106 μm. The magnetic substance powder 1D was not sieved.

### (Results of Limiting Steps Conducted in Different Manner)

TABLE 1 shows particle diameter distributions of Fe—Si—Al alloy powder obtained by using methods which differ from each other.

TABLE 1

| | Magnetic | Magnetic | Magnetic | Magnetic |
|---|---|---|---|---|
| | Substance | Substance | Substance | Substance |
| Magnetic Substance Powder | Powder 1A | Powder 1B | Powder 1C | Powder 1D |
| Fine-Grinding Time (Min.) | 90 | 180 | 90 | 90 |
| Opening of Sieve | 75 μm | None | 106 μm | None |
| Particle Diameter (μm) | Particle Size Distribution (%) | | | |
| 106 or Greater | 0 | 0 | 0 | 10 |
| 106 to 90 | 0 | 0 | 9 | 8 |
| 90 to 75 | 0 | 0 | 13 | 12 |
| 75 to 63 | 20 | 25 | 14 | 13 |
| 63 to 45 | 30 | 35 | 24 | 22 |
| Equal to or Lower than 45 | 50 | 40 | 40 | 35 |

The magnetic substance powder 1A and the magnetic substance powder 1C could be obtained, which had particle diameters equal to or lower than predetermined openings of sieves used for filtering the Fe—Si—Al alloy powder. In the magnetic substance powder 1D, the powder having particle diameters equal to or greater than 106 μm occupied 10%, and the powder having particle diameters equal to or greater than 75 μm occupied 30%. Although the magnetic substance powder 1B and the magnetic substance powder 1D were not sieved, every particle of the Fe—Si—Al alloy powder obtained a particle diameter equal to or lower than 75 μm by extending the grinding time.

### (Manufacturing Wire-Wound Inductor Core)

In an adding step, a Silicon resin was added by 3 wt % to four types of Fe—Si—Al alloy powder, i.e. the magnetic substance powder 1A and 1B; and the comparison example magnetic substance powder 1C and 1D, and then the powder and the Silicon resin were stirred.

In a molding step, columnar pressed bodys each having a size of 6 mm (φ)×4 mm (H) were manufactured by pressurizing each mixture of the Fe—Si—Al alloy powder and the Silicon with 47 kN (1.6×1030 MPa).

In a grinding step, wire-wound inductor cores each having 3 mm width and 1 mm depth are manufactured by grinding lateral surfaces of the pressed bodys by using a diamond cutter at grinding speeds of 0.2 mm/sec., 0.5 mm/sec., and 1.0 mm/sec.

In the following explanation, a core manufactured by using the magnetic substance powder 1A is referred to a core 1A; a core manufactured by using the magnetic substance powder 1B is referred to a core 1B; a core manufactured by using the magnetic substance powder 1C is referred to a core 1C; and a core manufactured by using the magnetic substance powder 1D is referred to a core 1D.

### (Method for Testing Cores)

In a testing method, the ground cores having underdone the grinding step were visually inspected, and then, the core having neither chipping and cracking on its flange parts, nor breakage on its center drum was rendered a non-defective core. Yield rates were obtained from the results of the test in which 100 pieces of compression molded cores were ground.

(Test Results after Mechanical Grinding)

TABLE 2

| | Example Core/ | | | | |
|---|---|---|---|---|---|
| | Comparison | Tested Magnetic | Grinding Speed and Yield Rate | | |
| Core Type | Example Core | Substance Powder | 0.2 mm/sec | 0.5 mm/sec | 1.0 mm/sec |
| Core 1A | Example core | Magnetic Substance | 100% | 100% | 50% |
| | | Powder 1A | | | |
| Core 1B | | Magnetic Substance | 100% | 100% | 70% |
| | | Powder 1B | | | |
| Core 1C | Comparison | Magnetic Substance | 80% | 0% | 0% |
| | Example Core | Powder 1C | | | |
| Core 1D | | Magnetic Substance | 20% | 0% | 0% |
| | | Powder 1D | | | |

TABLE 2 shows the results of testing the core 1A etc. The example core 1A and the example core 1B, made from the magnetic substance powder 1A and 1B respectively and having particle diameters limited equal to or lower than 75 μm, exhibited superior results, i.e. yield rates were higher than those of the comparison examples when they were ground at the grinding speeds of 0.2 mm/sec., 0.5 mm/sec., and 1.0 mm/sec.

The yield rate of the core 1D, of which particle diameter was not limited, was 20% when ground at the grinding speed of 0.2 mm/sec. On the other hand, the cores A to C, of which particle diameters were limited, exhibited superior yield rates of 80% or higher. Therefore, as a result, the magnetic substance powder, of which particle diameter was limited, exhibited superior yield rate.

The core 1A and the core 1B, which were made from powder having particle diameters equal to or lower than 75 μm and were ground at a higher grinding speed of, e.g. 0.5 mm/sec, exhibited the yield rate of 100%. On the other hand, the yield rate of the core 1C and the core 1D were 0%. These results indicated that, a wire-wound inductor core can be manufactured, even if it is ground at an increased grinding speed, by limiting the particle diameter of the powder equal to or lower than 75 μm.

In a further increased grinding speed of 1.0 mm/sec., the core 1A and the core 1B exhibited the yield rates of 50% and 70% respectively. This result indicated that the yield rates decreased if the grinding speeds were increased. However, the yield rates of the comparison example cores 1C and 1D were 0%. This revealed that the example cores 1A and 1B exhibited superior yield rates to those of the comparison example cores 1C and 1D.

The comparison example core 1D made from the magnetic substance powder 1D, of which particle diameter was not limited, exhibited a lower yield rate even though it was ground in a lower grinding speed. On the other hand, the magnetic substance powder 1C, which included the magnetic substance powder having particle diameter limited equal to or greater than 75 μm and being ground in a lower grinding speed, never reached to 100% of the yield rate, i.e. exhibited lower yield rates in every testing condition than those of the example cores.

In conclusion, the test results revealed that whether cracking or chipping will occur due to grinding operation depends on the particle diameter of magnetic substance powder used as material. In addition, the test results revealed that a wire-wound inductor core exhibiting a higher yield rate can be manufactured from magnetic substance powder having particle diameter equal to or lower than 75 μm.

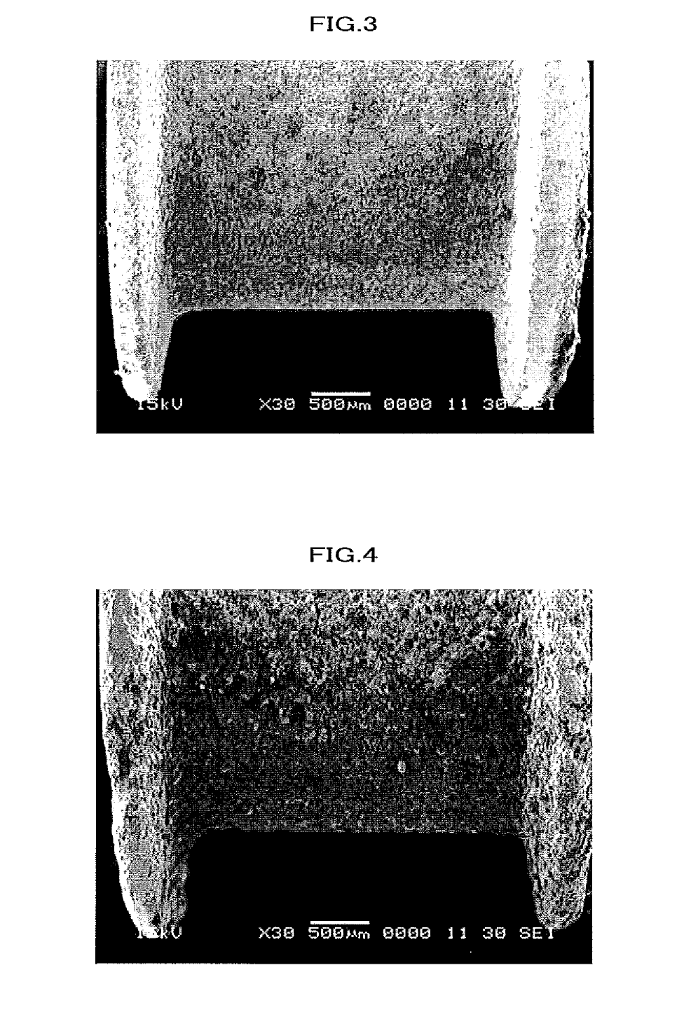

The core 1A and the comparison example core 1D were observed by using a field emission scanning electron microscope at an acceleration voltage of 15 kV and at a magnification of 30×. FIG. 3 shows a mechanically ground groove section of the core 1A made from the example powder 1A. FIG. 4 shows a mechanically ground groove section of the core 1d made from the example powder 1D. The core 1D has cracking and chipping on its surface more than those of the core 1A. In particular, in contrast to the flange parts of the core 1A having a gentle curve, the core 1D has notable size of chipping on its flange parts.

As explained above, the example 1 revealed that the core 1A was superior to the core 1D, and that the core 1A having fewer chipping or cracking can be a lower resistance magnetic circuit, which is usable as a core.

### (Measurement of Wire-Wound Inductor)

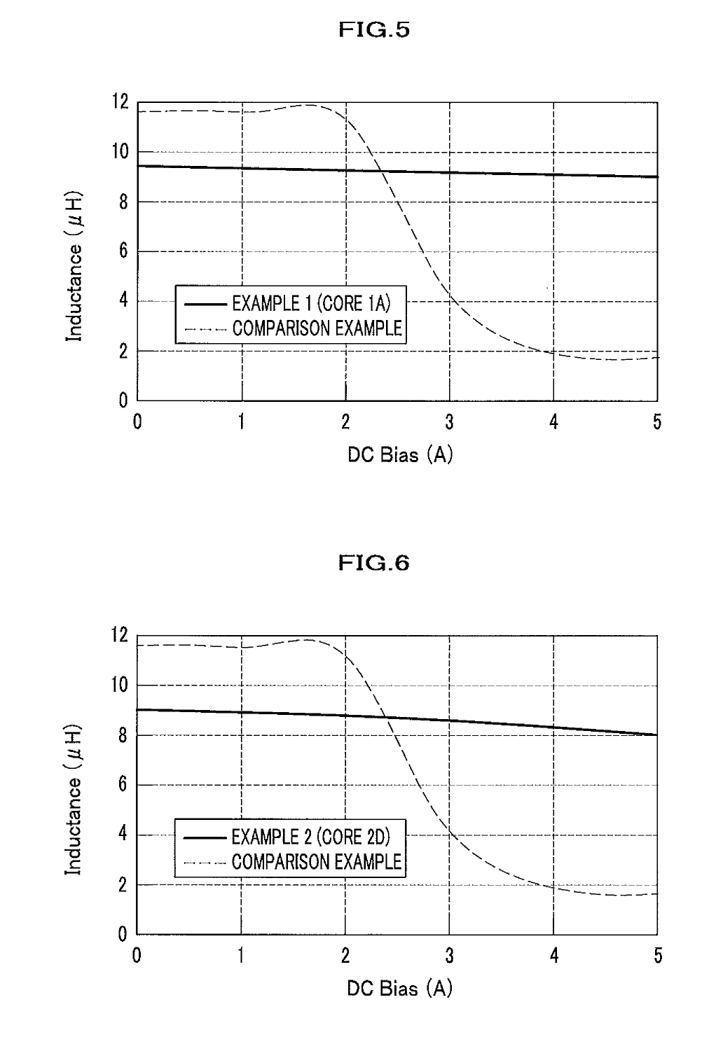

In the example 1, the DC bias characteristics of a wire-wound inductor was measured which was prepared by winding a copper wire around the groove section of the core 1A by 20 times. In a comparison example, the DC bias characteristics of a wire-wound inductor was measured, which was prepared by winding a copper wire around a groove section of a Ni—Cu—Zn sintered ferrite by 20 times having the identical shape with that of the core 1A. FIG. 5 shows the result of measurements. In FIG. 5, a curve shown in broken line indicates the inductance of a comparison example core. The inductance was 12 μH when 1A of electric current passes through the comparison example core. The inductance dropped rapidly when 2A or higher of electric current passed therethrough. The inductance was 4 μH at 3A of electric current.

On the other hand, a solid line indicates the inductance obtained in the example 1. The inductance was 9.3 μH, and was lower than that of a wire-wound inductor using a sintered ferrite core when a low electric current e.g. 1A passed therethrough. However, the inductance experienced little change at a greater electric current. The example core 1A exhibited a higher inductance than that of the comparison example from 2 to 3A of electric current.

As explained above, the measurement results revealed that the example wire-wound inductor had superior DC bias characteristics to that of the wire-wound inductor using a sintered ferrite core.

### Example 2

In an example 2, various types of Fe—Si—Al alloy powder were used which were obtained by modifying the content ratio of the Fe—Si—Al alloy powder of the example 1. The content ratio of particle having particle diameter equal to or lower than 75 μm was differentiated among the various types of the Fe—Si—Al alloy powder.

### (Preparation of Magnetic Substance Powder)

The content ratios of magnetic substance powder 2A to 2F prepared in the example 2 were differentiated from each other, and they were modified from that of the magnetic substance powder 1A of the example 1 in which the content ratio of Fe:Si:Al was 85:9.5:5.5. In the example 2, the various types of Fe—Si—Al alloy powder were obtained by machine comminution performed similarly to the example powder 1A.

TABLE 3

| Magnetic Substance Powder | Content Ratio of Fe:Si:Al |
|---|---|
| Magnetic Substance Powder 2A | 89:4:7 |
| Magnetic Substance Powder 2B | 88:6:6 |
| Magnetic Substance Powder 2C | 87:8.5:4.5 |
| Magnetic Substance Powder 2D | 85:9.5:5.5 |
| Magnetic Substance Powder 2E | 84.5:10: 5.5 |
| Magnetic Substance Powder 2F | 83:13:4 |

### (Limiting Particle Diameter of Magnetic Substance Powder)

The various types of the magnetic substance powder 2A to 2F have particle diameters equal to or lower than 75 μm obtained in a limiting step conducted similarly to that of the example 1 in which the magnetic substance powder 1A in was prepared.

In addition, magnetic substance powder having particle diameter equal to or greater than 75 μm was mixed to the various types of the magnetic substance powder 2A to 2F. Content ratio of particles having particle diameters equal to or lower than 75 mm was differentiated among the magnetic substance powder 2A to 2F. It should be noted that, the content ratio was equal to or lower than 80% in the comparison examples.

### (Manufacturing Cores)

A process of manufacturing a core including an adding step etc. was similar to that performed in the example 1. Cores manufactured by using the magnetic substance powder 2A to 2F are referred to cores 2A to 2F respectively (See TABLE 4 for detail).

(Test Results after Mechanical Grinding)

The example 2 used the same testing method as that used in the example 1. The following TABLE 4 shows the results of testing the cores 2A to 2F each having content ratio modified from that of the example 1 and differentiated from each other.

TABLE 4

| | | | Content ratio of Magnetic | | | |
|---|---|---|---|---|---|---|
| | Magnetic Substance | Example Core/ | Substance Powder having | | | |
| | Powder (Content | Comparison | Particle diameter Equal to | Grinding Speed and Yield Rate | | |
| Core | Ratio of Fe:Si:Al) | Example Core | or Lower than 75 μm | 0.2 mm/sec | 0.5 mm/sec | 1.0 mm/sec |
| Core 2A | Magnetic Substance | Example Core | 100% | 100% | 100% | 60% |
| | Powder 2A | | 90% | 95% | 40% | 0% |
| | (89:4:7) | Comparison | 80% | 40% | 10% | 0% |
| | | Example Core | 70% | 25% | 0% | 0% |
| Core 2B | Magnetic Substance | Example Core | 100% | 100% | 100% | 55% |
| | Powder 2B | | 90% | 95% | 40% | 0% |
| | (88:6:6) | Comparison | 80% | 40% | 10% | 0% |
| | | Example Core | 70% | 25% | 0% | 0% |
| Core 2C | Magnetic Substance | Example Core | 100% | 100% | 100% | 50% |
| | Powder 2C | | 90% | 90% | 40% | 0% |
| | (87:8.5:4.5) | Comparison | 80% | 40% | 10% | 0% |
| | | Example Core | 70% | 25% | 0% | 0% |
| Core 2D | Magnetic Substance | Example Core | 100% | 100% | 100% | 50% |
| | Powder 2D | | 90% | 90% | 40% | 0% |
| | (85:9.5:5.5) | Comparison | 80% | 40% | 10% | 0% |
| | | Example Core | 70% | 20% | 0% | 0% |
| Core 2E | Magnetic Substance | Example Core | 100% | 100% | 100% | 50% |
| | Powder 2E | | 90% | 90% | 35% | 0% |
| | (84.5:10:5.5) | Comparison | 80% | 35% | 10% | 0% |
| | | Example Core | 70% | 20% | 0% | 0% |
| Core 2F | Magnetic Substance | Example Core | 100% | 100% | 100% | 50% |
| | Powder 2F | | 90% | 85% | 30% | 0% |
| | (83:13:4) | Comparison | 80% | 30% | 0% | 0% |
| | | Example Core | 70% | 15% | 0% | 0% |

The cores 2A to 2F were made from the Fe—Si—Al alloy powder each having the content ratio differentiated from each other, and were ground at various grinding speeds which were differentiated from each other. The cores 2A to 2F exhibited yield rates similar to each other. Also, yield rates increased in these cores if ground at a decreased grinding speed.

More specifically, yield rates of the comparison example cores having the content ratios of 70% to 80% did not exceed 40% even if the grinding speed was 0.2 mm. When the grinding speed was 1.0 mm, the yield rate was 0%, that is, the cores were all defective.

On the other hand, the example cores, having the content ratios equal to or greater than 90% and ground at 0.2 mm, exhibited yield rates of 85% to 95% which were superior to those of the comparison example cores.

In particular, the cores having the content ratio of 100% and ground at 0.2 mm, or 0.5 mm, exhibited very excellent yield rate of 100%, and the test revealed that cores could be manufactured even if the grinding speed was 1.0 mm.

As explained above, the cores made from the magnetic substance powder exhibited superior yield rate if the content ratio of particle diameter 75 μm was equal to or greater than 90%.

### (Measurement of Wire-Wound Inductor)

In the example 2, the DC bias characteristics of a wire-wound inductor, made from the magnetic substance powder 2D (of which content ratio is 90%) and obtained by winding a copper wire around the groove section of the core 2D by 20 times, were measured. FIG. 6 shows the result of measurements. FIG. 6 also shows the DC bias characteristics of a comparison example wire-wound inductor obtained by winding a copper wire around a groove section of a Ni—Cu—Zn sintered ferrite. The comparison example wire-wound inductor was referred to in the example 1 and had the identical shape with that of the core 1A. In FIG. 6, a solid line indicates the example 2, and a broken line indicates a comparison example. The inductance obtained in the example 2 was 9.0 μH and was lower than that of the comparison example when a low electric current, e.g. 0 to 1A, passed therethrough. After that, the inductance decreased gradually while the electric current was increased to 5A. Unlike the comparison example, a rapid drop of inductance was not observed in the vicinity of electric current from 2A or higher.

The measurement results proved that the example wire-wound inductors had superior DC bias characteristics to those of the wire-wound inductors using sintered ferrite cores.

### Example 3

A step for obtaining Fe—Si—Al alloy powder, i.e. the magnetic substance powder 1A used in the example 1, was modified in an example 3. More specifically, the example 3 used magnetic substance powder obtained by atomization of alloy in place of machine comminution of alloy. In addition, Fe—Si—Al alloy powder of the example 3 had a content ratio similar to that of the example 2.

### (Preparation of Magnetic Substance Powder)

Fe—Si—Al alloy powder obtained by atomization of Fe—Si—Al alloy had content ratios shown in TABLE 5 as follows.

TABLE 5

| Magnetic Substance Powder | Content Ratio of Fe:Si:Al |
|---|---|
| Magnetic Substance Powder 3A | 89:4:7 |
| Magnetic Substance Powder 3B | 88:6:6 |
| Magnetic Substance Powder 3C | 87:8.5:4.5 |
| Magnetic Substance Powder 3D | 85:9.5:5.5 |
| Magnetic Substance Powder 3E | 84.5:10:5.5 |
| Magnetic Substance Powder 3F | 83:13:4 |

### (Limiting Particle Diameter of Magnetic Substance Powder)

The example powder 3A to 3F were limited to have particle diameters equal to or lower than 75 μm by using a method similar to that performed in the example 2. Magnetic substance powder having particle diameter equal to or greater than 75 μm was mixed to the various types of the magnetic substance powder 3A to 3F, and then, content ratio of particles having particle diameters equal to or lower than 75 mm was differentiated among the magnetic substance powder 3A to 3F similarly to the example 2. It should be noted that, the content ratio was equal to or lower than 80% in the comparison examples.

### (Manufacturing Cores)

Cores were manufactured by using a process similar to that performed in the example 1.

(Test Results after Mechanical Grinding)

The example 3 used the same testing method as that used in the example 1. TABLE 6 shows the results of testing the magnetic substance powder 3A to 3F as follows.

TABLE 6

| | | | Contents Ratio of Magnetic | | | |
|---|---|---|---|---|---|---|
| | Magnetic Substance | Example Core/ | Substance Powder having | | | |
| | Powder (Content | Comparison | Particle diameter Equal to | Grinding Speed and Yield Rate | | |
| Core | Ratio of Fe:Si:Al) | Example Core | or Lower than 75 μm | 0.2 mm/sec | 0.5 mm/sec | 1.0 mm/sec |
| Core 3A | Magnetic Substance | Example Core | 100% | 100% | 80% | 50% |
| | Powder 3A | | 90% | 65% | 40% | 10% |
| | (89:4:7) | Comparison | 80% | 45% | 5% | 0% |
| | | Example Core | 70% | 10% | 0% | 0% |
| Core 3B | Magnetic Substance | Example Core | 100% | 100% | 80% | 50% |
| | Powder 3B | | 90% | 60% | 30% | 10% |
| | (88:6:6) | Comparison | 80% | 45% | 0% | 0% |
| | | Example Core | 70% | 0% | 0% | 0% |
| Core 3C | Magnetic Substance | Example Core | 100% | 100% | 80% | 50% |
| | Powder 3C | | 90% | 60% | 30% | 10% |
| | (87:8.5:4.5) | Comparison | 80% | 40% | 0% | 0% |
| | | Example Core | 70% | 0% | 0% | 0% |
| Core 3D | Magnetic Substance | Example Core | 100% | 100% | 80% | 50% |
| | Powder 3D | | 90% | 60% | 30% | 10% |
| | (85:9.5:5.5) | Comparison | 80% | 40% | 0% | 0% |
| | | Example Core | 70% | 0% | 0% | 0% |
| Core 3E | Magnetic Substance | Example Core | 100% | 100% | 70% | 40% |
| | Powder 3E | | 90% | 50% | 30% | 10% |
| | (84.5:10:5.5) | Comparison | 80% | 40% | 0% | 0% |
| | | Example Core | 70% | 0% | 0% | 0% |
| Core 3F | Magnetic Substance | Example Core | 100% | 100% | 60% | 40% |
| | Powder 3F | | 90% | 50% | 20% | 5% |
| | (83:13:4) | Comparison | 80% | 40% | 0% | 0% |
| | | Example Core | 70% | 0% | 0% | 0% |

The yield rates of the cores 3A to 3F, which were made from Fe—Si—Al alloy powder obtained by atomization in place of metal comminution conducted in example 2, decreased uniformly when the content ratio of Si increased. On the other hand, the yield rates improved when Fe and Al increased in content ratio.

More specifically, a comparison example core 3A was barely manufactured, and no comparison example cores 3B to 3F could be manufactured when the content ratio was 70%. The example cores having content ratio of 90% exhibited remarkable increase in yield rates which were equal to or greater than 50%.

In particular, the example cores exhibited yield rates of 40% or greater if the content ratio was 100%. This yield rate is better than those of most of the comparison cores, which exhibited 0% of yield rate if they were ground at 0.5 mm/sec. or faster.

The test results also revealed that it was possible to manufacture a wire-wound inductor core if magnetic substance powder, obtained by atomization in place of metal comminution and having particle diameter limited to 75 μm or lower, had content ratio eaual to or higher than 90%.

### (Measurement of Wire-Wound Inductor)

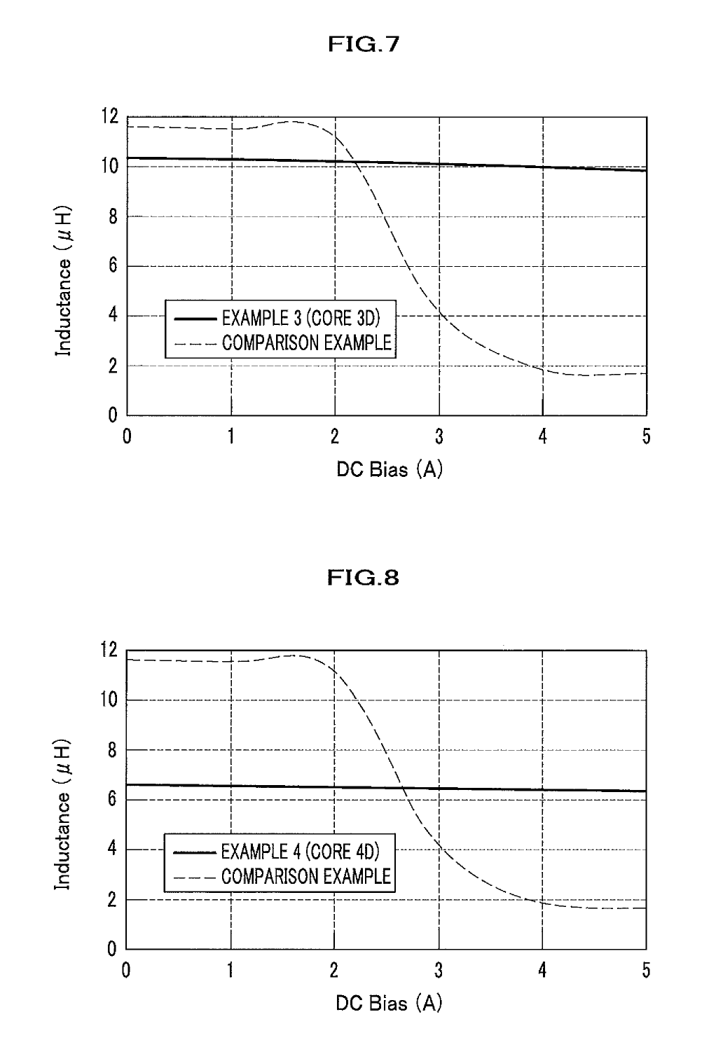

A wire-wound inductor of the example 3 was prepared by winding a copper wire around the groove section of the core 3D by 20 times which used the magnetic substance powder 3D (of which content ratio is 100%). The DC bias characteristics of the wire-wound inductor of the example 3 were measured. FIG. 7 shows the result of measurements. In addition, FIG. 7 shows the DC bias characteristics of a comparison example wire-wound inductor, which was referred to in the example 1 and was prepared by winding a copper wire around the groove section of a Ni—Cu—Zn sintered ferrite by 20 times, which had the identical shape with that of the core 1A. In FIG. 7, a solid line indicates the example 3, and a broken line indicates a comparison example. The inductance obtained in the example 3 was 10.4 μH and was lower than that of the comparison example when a low electric current, e.g. 0 to 1A, passed therethrough. In addition, the inductance decreased gradually but in few degree while increasing the electric current. Unlike the comparison example, a rapid drop of inductance was not observed in the example 3. The example cores exhibited inductances higher than those of the comparison examples at electric currents 2A or higher.

The measurement results proved that the example wire-wound inductors had superior DC bias characteristics to those of the wire-wound inductors using sintered ferrite cores.

### Example 4

An example 4 used Fe—Si—B amorphous alloy powder, i.e. Fe—Si—Al alloy powder, in place of the magnetic substance powder used in the examples 1 to 3.

### (Preparation of Magnetic Substance Powder)

The magnetic substance powder, i.e. Fe—Si—B amorphous alloy powder was obtained by atomization. Four samples 4-1 to 4-4 of Fe—Si—B amorphous alloy powder had content ratios as shown in TABLE 7.

TABLE 7

| Magnetic Substance Powder | Content Ratio of Fe:Si:B |
|---|---|
| Magnetic Substance Powder 4A | 75:8:17 |
| Magnetic Substance Powder 4B | 78:7:15 |
| Magnetic Substance Powder 4C | 80:6:14 |
| Magnetic Substance Powder 4D | 83:5:12 |

### (Limiting Particle Diameter of Magnetic Substance Powder)

The particle diameter of magnetic substance powder 4A was limited by using a sieve having an opening of 75 μm in a similar manner conducted to the example powder 1A used in the example 1.

In addition, the content ratio was varied among the example powder 4A to 4D by adding non-sieved particles existing on the sieve and having particle diameters equal to or greater than 75 μm to the particles sieved in similar manner conducted to the examples 2 and 3. It should be noted that, the content ratio was equal to or lower than 80% in the comparison examples.

### (Manufacturing Cores)

Cores were manufactured by using a process similar to that performed in the example 1.

(Test Results after Mechanical Grinding)

The example 4 used the same testing method as that used in the example 1. TABLE 8 shows the results of testing the magnetic substance powder 4A to 4D as follows.

TABLE 8

| | | | Contents Ratio of Magnetic | | | |
|---|---|---|---|---|---|---|
| | Magnetic Substance | Example Core/ | Substance Powder having | | | |
| | Powder (Content | Comparison | Particle diameter Equal to | Grinding Speed and Yield Rate | | |
| Core | Ratio of Fe:Si:B) | Example Core | or Lower than 75 μm | 0.2 mm/sec | 0.5 mm/sec | 1.0 mm/sec |
| Core 4A | Magnetic Substance | Example Core | 100% | 100% | 100% | 100% |
| | Powder 4A | | 90% | 100% | 95% | 90% |
| | (75:8:17) | | 85% | 80% | 45% | 20% |
| | | Comparison | 80% | 50% | 10% | 0% |
| | | Example Core | | | | |
| Core 4B | Magnetic Substance | Example Core | 100% | 100% | 100% | 100% |
| | Powder 4B | | 90% | 100% | 90% | 80% |
| | (78:7:15) | | 85% | 80% | 45% | 20% |
| | | Comparison | 80% | 40% | 10% | 0% |
| | | Example Core | | | | |
| Core 4C | Magnetic Substance | Example Core | 100% | 100% | 100% | 100% |
| | Powder 4C | | 90% | 100% | 90% | 80% |
| | (80:6:14) | | 85% | 80% | 40% | 20% |
| | | Comparison | 80% | 40% | 10% | 0% |
| | | Example Core | | | | |
| Core 4D | Magnetic Substance | Example Core | 100% | 100% | 100% | 80% |
| | Powder 4D | | 90% | 100% | 80% | 70% |
| | (83:5:12) | | 85% | 70% | 40% | 10% |
| | | Comparison | 80% | 30% | 10% | 0% |
| | | Example Core | | | | |

The test results revealed that the variation of content ratio of the magnetic substance powder 4A to 4D, i.e. Fe—Si—B alloy powder used for manufacturing the cores 4A to 4D scarcely affected the yield rates.

More specifically, the comparison example cores 4A to 4D exhibited yield rates of 30% to 50% if the content ratio was 80% and if they were ground at a grinding speed of 0.2 mm/sec. In contrast, the example cores exhibited remarkably increased yield rates of 70% to 80% if the content ratio was 85%. In addition, the example cores exhibited the superior yield rate of 100% if the content ratio was equal to or greater than 90%.

In particular, the example cores exhibited remarkably increased yield rates of 70% to 90% if the content ratio was 90% and the grinding speed was 1.0 mm/sec. If the content ratio was 100%, the example core D exhibited a yield rate of 80% and the example cores A, B, and C exhibited the superior yield rate of 100%.

In addition, the test results revealed that it is possible to manufacture a wire-wound inductor core if the content ratio of magnetic substance powder having particle diameter equal to or lower than 75 μm is equal to or higher than 85%. In addition, the test results revealed that remarkably superior yield rates of 80% to 100% could be achieved in a higher grinding speed of 1.0 mm if the content ratio was 100%.

### (Measurement of Wire-Wound Inductor)

A wire-wound inductor of the example 4 was prepared by winding a copper wire around the groove section of the core 4D by 20 times which used the magnetic substance powder 4D (of which content ratio was 100%). The DC bias characteristics of the wire-wound inductor were measured. FIG. 8 shows the result of measurements. In addition, FIG. 8 shows the DC bias characteristics of a comparison example wire-wound inductor, which was referred to in the example 1 and was prepared by winding a copper wire around the groove section of a Ni—Cu—Zn sintered ferrite by 20 times, which had the identical shape with that of the core 1A. In FIG. 8, a solid line indicates the example 4, and a broken line indicates a comparison example. The inductance obtained in the example 4 was 6.3 μH and was lower than that of the comparison example by almost 5A when a low electric current, e.g. 0 to 1A, passed therethrough. The inductance decreased gradually and in very few degree while increasing the electric current from 4A to 5A, or to higher amperage. Unlike the comparison example, a rapid drop of inductance was not observed in the example 4, and the example cores exhibited inductances higher than those of the comparison examples at electric currents 2A or higher.

The test results proved that the example wire-wound inductors had superior DC bias characteristics to those of the wire-wound inductors using sintered ferrite cores.

### Example 5

In an example 5, Fe—Si alloy powder was prepared by atomization.

### (Preparation of Magnetic Substance Powder)

The following TABLE 9 shows the content ratio of Fe—Si alloy powder obtained by atomization in the present example as previously explained.

TABLE 9

| Magnetic Substance Powder | Content Ratio of Fe:Si |
|---|---|
| Magnetic Substance Powder 5A | 96:4 |
| Magnetic Substance Powder 5B | 93.5:6.5 |
| Magnetic Substance Powder 5C | 92:8 |

### (Limiting Particle Diameter of Magnetic Substance Powder)

The magnetic substance powder 5A to 5C are samples, of which particle diameters were limited equal to or lower than 45 μm by using a sieve having an opening of 45 μm in a step of limiting the particle diameter of the magnetic substance powder 5A to 5C.

The content ratio was varied among the magnetic substance powder 5A to 5C as shown in the TABLE 10 by adding non-sieved particles existing on the sieve and having particle diameters equal to or greater than 45 μm to the sieved particles. It should be noted that, the content ratio was equal to or lower than 60% in the comparison examples.

### (Step of Manufacturing Cores)

Cores were manufactured by using a process similar to that performed in the example 1.

(Test Results after Mechanical Grinding)

The example 5 used the same testing method as that used in the example 1.

TABLE 10 shows the results of testing the magnetic substance powder 5A to 5C as follows.

TABLE 10

| | Magnetic Substance | | Content ratio of Fe—Si | | | |
|---|---|---|---|---|---|---|
| | Powder (Content | Example Core/ | Alloy Powder having | | | |
| | Ratio of Fe—Si | Comparison | Particle diameter Equal to | Grinding Speed and Yield Rate | | |
| Core | Alloy Powder) | ExampleCore | or Lower than 45 μm | 0.2 mm/sec | 0.5 mm/sec | 1.0 mm/sec |
| Core 5A | Magnetic Substance | Example Core | 100% | 100% | 100% | 70% |
| | Powder 5A | | 90% | 90% | 80% | 60% |
| | (96:4) | | 80% | 70% | 20% | 0% |
| | | Comparison | 60% | 40% | 10% | 0% |
| | | Example Core | | | | |
| Core 5B | Magnetic Substance | Example Core | 100% | 100% | 100% | 70% |
| | Powder 5B | | 90% | 90% | 80% | 60% |
| | | | 80% | 70% | 20% | 0% |
| | (93.5:6.5) | Comparison | 60% | 30% | 10% | 0% |
| | | Example Core | | | | |
| Core 5C | Magnetic Substance | Example Core | 100% | 90% | 90% | 60% |
| | Powder 5C | | 90% | 90% | 70% | 60% |
| | (92:8) | | 80% | 60% | 20% | 0% |
| | | Comparison | 60% | 20% | 0% | 0% |
| | | Example Core | | | | |

Comparison of the cores 5A to 5C made from Fe—Si alloy powder shown in TABLE 10 revealed that the cores 5A having Fe content ratio greater than those of the cores 5C exhibited generally higher yield rates than those of the cores 5C.

In addition, the yield rate improved if the content ratio of magnetic substance powder having particle diameter of 45 μm was higher similarly to other examples.

In particular, when the grinding speed was 1.0 mm/sec., the yield rate was 0%, that is, the example cores 5A to 5C having content ratio equal to or lower than 80% were all defective. However, every core exhibited a yield rate of 60% if the content ratio was 90%, and the core 5A and the core 5B exhibited a higher yield rate of 70% if the content ratio was 100%.

The test results revealed that a wire-wound inductor core could be manufactured if the content ratio of magnetic substance powder having particle diameter equal to or lower than 45 μm was equal to or higher than 80%.

### (Measurement of Wire-Wound Inductor)

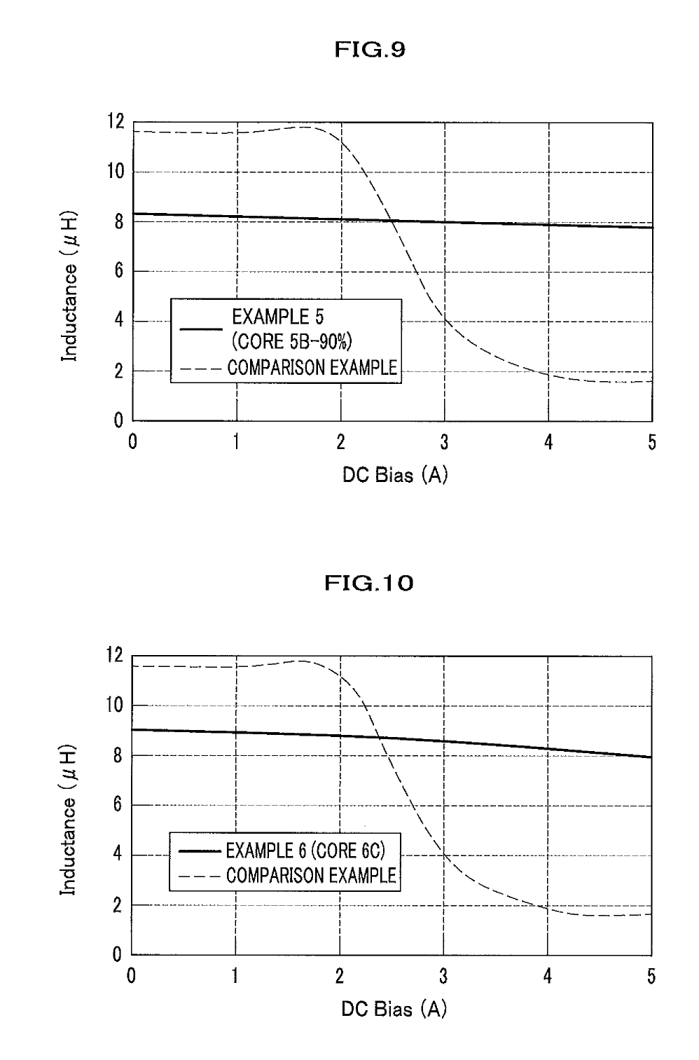

A wire-wound inductor of the example 5 was prepared by winding a copper wire around the groove section of the core 5B by 20 times which used the magnetic substance powder 5B (of which content ratio was 90%). The DC bias characteristics of the wire-wound inductor were measured. FIG. 9 shows the result of measurements. In addition, FIG. 9 shows the DC bias characteristics of a comparison example wire-wound inductor which was referred to in the example 1 and was prepared by winding a copper wire around the groove section of a Ni—Cu—Zn sintered ferrite by 20 times. The comparison example wire-wound inductor had the identical shape with that of the core 1A. In FIG. 9, a solid line indicates the example 5, and a broken line indicates a comparison example. The inductance obtained in the example 5 was 8.2 μH and was lower than that of the comparison example when a low electric current, e.g. 0 to 1A, passed therethrough. A rapid drop of inductance was not observed if electric current was increased. Therefore, the example 5 exhibited higher inductance from 2.5A up than that of the comparison example exhibiting inductance rapidly decreasing from 2.5A up.

The test results proved that the example wire-wound inductors had superior DC bias characteristics to those of the wire-wound inductors using sintered ferrite cores.

### Example 6

In the example 6, the step for manufacturing the core 2D made from the magnetic substance powder 2D as shown in the example 2 was modified. More specifically, the grinding step of the example 2 was modified in the example 6.

### (Preparing Magnetic Substance Powder and Limiting Particle Diameter)

The example 6 used the magnetic substance powder of the example 2, i.e. the example powder 2D (the content ratio of Fe:Si:Al in the Fe—Si—Al alloy powder was 85:9.5:5.5). In addition, four types of mixed magnetic material powder similar to those of the example 2 were prepared, in which content ratios of particle diameter equal to or lower than 75 μm were 100%, 90%, 80%, and 70%. It should be noted that, the content ratio was equal to or lower than 80% in the comparison examples.

### (Manufacturing Cores)

In a molding step, columnar pressed bodys each having a size of 6 mm (φ)×4 mm (H) were manufactured by using the adding step and the compressing step similar to those performed in the example 1.

However, in a step for grinding the pressed bodys, grinding depths were set at 1 mm, 1.5 mm, 2 mm, and 2.5 mm. (Note that the pressed bodys ground in the grinding step are designated as cores 6A, 6B, 6C, and 6D).

In addition, lateral surfaces of the pressed bodys were ground in 3 mm width by using a diamond cutter at a grinding speed of 0.2 mm/sec., 0.5 mm/sec., or 1.0 mm/sec. in the grinding step similarly to that conducted in the example 1.

(Test Results after Mechanical Grinding)

The example 6 used the same testing method as that used in the example 1. TABLE 11 shows test results as follows.

TABLE 11

| | Depth of Groove (Ratio | | Contents Ratio of Fe—Si—Al | | | |
|---|---|---|---|---|---|---|
| | between Diameter of | Example Core/ | Alloy Powder having | | | |
| | pressed body and | Comparison | Particle diameter Equal to | Grinding Speed and Yield Rate | | |
| Core | Depth of Groove) | Example Core | or Lower than 75 μm | 0.2 mm/sec | 0.5 mm/sec | 1.0 mm/sec |
| Core 6A | 1 mm | Example Core | 100% | 100% | 100% | 50% |
| | (1/3) | | 90% | 90% | 40% | 0% |
| | | Comparison | 80% | 80% | 0% | 0% |
| | | Example Core | 70% | 20% | 0% | 0% |
| Core 6B | 1.5 mm | Example Core | 100% | 100% | 100% | 50% |
| | (1/2) | | 90% | 90% | 40% | 0% |
| | | Comparison | 80% | 70% | 0% | 0% |
| | | Example Core | 70% | 20% | 0% | 0% |
| Core 6C | 2 mm | Example Core | 100% | 100% | 100% | 30% |
| | (2/3) | | 90% | 80% | 40% | 0% |
| | | Comparison | 80% | 70% | 0% | 0% |
| | | Example Core | 70% | 10% | 0% | 0% |
| Core 6D | 2.5 mm | Example Core | 100% | 100% | 90% | 20% |
| | (5/6) | | 90% | 70% | 40% | 0% |
| | | Comparison | 80% | 50% | 0% | 0% |
| | | Example Core | 70% | 0% | 0% | 0% |

Comparison of the cores 6A, 6B, 6C, and 6D revealed that the cores 6D, on which deeper grooves were ground, generally exhibited lower yield rates than those of the cores 6A. Therefore, the test results revealed that the yield rates decreased if deeper grooves were ground.

When the grinding speed was 0.5 mm/sec. and the content ratio was 70% or 80%, the yield rate of the comparison cores was 0%, that is, the comparison cores were all defective.

In contrast, the example cores exhibited 40% of yield rate when the content ratio was 90%, and exhibited remarkably superior yield rates of 90% to 100% when the content ratio was 100%.

As explained above, the test results revealed that a wire-wound inductor core could be manufactured if the content ratio of Fe—Si—Al alloy powder having particle diameter equal to or lower than 75 μm was equal to or higher than 90%.

### (Measurement of Wire-Wound Inductor)

A wire-wound inductor of the example 6 was prepared by winding a copper wire around the groove section (having 2 mm depth) of the core 6C by 20 times which used the magnetic substance powder 6C (of which content ratio was 100%). The DC bias characteristics of the wire-wound inductor were measured. FIG. 10 shows the result of measurements. In addition, FIG. 10 shows the DC bias characteristics of a comparison example wire-wound inductor which was prepared by winding a copper wire around the groove section of a Ni—Cu—Zn sintered ferrite by 20 times, which had the identical shape with that of the core 1A used in the example 1. In FIG. 10, a solid line indicates the example 6, and a broken line indicates a comparison example.

The inductance obtained in the example 6 was 8.7 μH and was lower than that of the comparison example, when a low electric current, e.g. 0 to 1A, passed therethrough. The inductance decreased gradually when electric current was increased from 3A to 4A, and to 5A. However, a rapid drop of inductance analogous to the comparison examples was not observed. Therefore, the example 6 exhibited a higher inductance than that of the comparison example when 2.5A of electric current passed therethrough.

As explained above, the test results proved that the example wire-wound inductors had superior DC bias characteristics to those of the wire-wound inductors using sintered ferrite cores even if the deeper groove sections were ground on the example wire-wound inductors.

### Example 7

In an example 7, a compression-molding step and a grinding step were modified from those performed in the example 2 for compressing and grinding the magnetic substance powder 2D.

(Preparing Magnetic Substance Powder and Limiting Particle diameter)

The example 6 used the magnetic substance powder of the example 2, i.e. the example powder 2D (the content ratio of Fe:Si:Al in the Fe—Si—Al alloy powder was 85:9.5:5.5). In addition, four types of mixed magnetic material powder similar to those of the example 2 were prepared, in which content ratios of particle diameter equal to or lower than 75 μm were 100%, 90%, 80%, and 70%. It should be noted that, the content ratio was equal to or lower than 80% in the comparison examples.

### (Manufacturing Cores)

An additing step was performed similarly to the example 1. Pressed bodies manufactured in a molding step were: a round column (core 7A) 6 mm (φ) and 4 mm (H); a round column (core 7B) 4 mm (φ) and 3 mm (H); a round column (core 7C) 3 mm (φ) and 2 mm (H); a square column (core 7D) 6 mm square and 4 mm (H); and a hexagonal column (core 7E) 3 mm per side and 4 mm (H).

Although the grinding step was performed similarly to that of the example 1, each core has a width of groove which differs among the cores. (See TABLE 12).

(Test Results after Mechanical Grinding)

The example 7 used the same testing method as that used in the example 1. TABLE 12 shows test results as follows.

TABLE 12

| | Pressed Body | | | | Contents Ratio of Magnetic | | | |
|---|---|---|---|---|---|---|---|---|
| | | Size (φ: | | Example Core/ | Substance Powder having | | | |
| | | Diameter, | Width of | Comparison | Particle diameters Equal to | Grinding Speed and Yield Rate | | |
| Core | Shape | H: Height) | Groove | Example Core | or Lower than 75 μm | 0.2 mm/sec | 0.5 mm/sec | 1.0 mm/sec |
| Core 7A | Round | 6 mm (φ) | 3 mm | Example Core | 100% | 100% | 100% | 50% |
| | Column | and | | | 90% | 90% | 40% | 0% |
| | | 4 mm (H) | | Comparison | 80% | 80% | 0% | 0% |
| | | | | Example Core | 70% | 20% | 0% | 0% |
| Core 7B | Round | 4 mm (φ) | 2 mm | Example Core | 100% | 100% | 100% | 50% |
| | Column | and | | | 90% | 90% | 40% | 0% |
| | | 3 mm (H) | | Comparison | 80% | 80% | 0% | 0% |
| | | | | Example Core | 70% | 20% | 0% | 0% |
| Core 7C | Round | 3 mm (φ) | 1 mm | Example Core | 100% | 100% | 100% | 40% |
| | Column | and | | | 90% | 90% | 35% | 0% |
| | | 2 mm (H) | | Comparison | 80% | 75% | 0% | 0% |
| | | | | Example Core | 70% | 20% | 0% | 0% |
| Core 7D | Square | 6 mm square | 3 mm | Example Core | 100% | 90% | 80% | 40% |
| | Column | and | | | 90% | 60% | 25% | 0% |
| | | 4 mm (H) | | Comparison | 80% | 50% | 0% | 0% |
| | | | | Example Core | 70% | 15% | 0% | 0% |
| Core 7E | Hexagonal | 3 mm per | 3 mm | Example Core | 100% | 90% | 70% | 40% |
| | Column | side and | | | 90% | 60% | 20% | 0% |
| | | 4 mm (H) | | Comparison | 80% | 50% | 0% | 0% |
| | | | | Example Core | 70% | 10% | 0% | 0% |

Unlike the round column cores, polygonal cores did not exhibit 100% of yield rate even if the grinding speed was 0.2 mm/sec. and if the content ratio was 100%.

In contrast, the round column cores 7A to 7C exhibited 100% of yield rate if the content ratio was 100% and the grinding speed was 0.5 mm/sec. This revealed that round column cores were generally invulnerable to chipping and cracking.

However, if the grinding speed was 0.2 mm/sec. and if the content ratio was 100%, the polygonal column cores exhibited 90% of yield rate, which was 75% to 80% increase from the yield rate of the comparison example having 70% of content ratio.

The polygonal column cores exhibited 0% of yield rate, i.e. the polygonal column cores having content ratio of 80% were all defective if the grinding speed was 0.5 mm/sec. However, it was possible to manufacture a core in 20% of yield rate if the content ratio was 90%.

Therefore, the test results revealed that it was possible to manufacture polygonal column cores at a faster grinding speed as long as the content ratio of particles having particle diameter equal to or lower than 75 μm was 90% or higher.

### (Measurement of Wire-Wound Inductor)

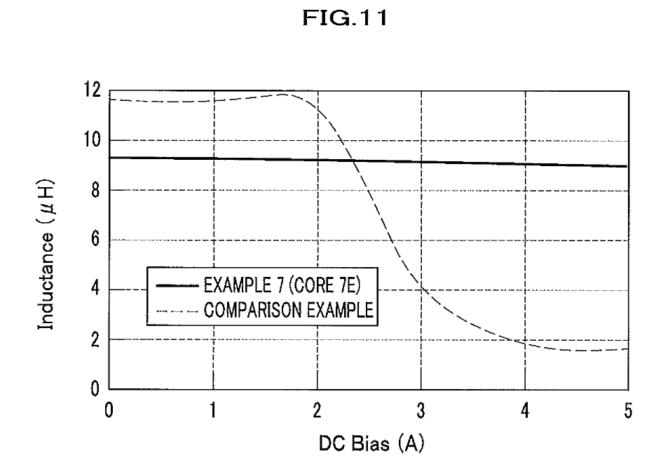

A wire-wound inductor of the example 7 was prepared by winding a copper wire around the groove section of the core 7E by 20 times which used the magnetic substance powder 7E (of which content ratio was 100%). The DC bias characteristics of the wire-wound inductor were measured. FIG. 11 shows the result of measurements. In addition, FIG. 11 shows the DC bias characteristics of a comparison example wire-wound inductor which was used in the example 1 and was prepared by winding a copper wire around the groove section of a Ni—Cu—Zn sintered ferrite by 20 times, which had the identical shape with that of the core 1A. In FIG. 11, a solid line indicates the example 7, and a broken line indicates a comparison example. The inductance of the example 7 was 8.2 μH and was lower than that of the comparison example, when a low electric current, e.g. 0 to 1A, passed therethrough. A rapid drop of inductance was not observed if electric current was increased. Therefore, the example 7 exhibited higher inductance from 2.5A up than that of the comparison example exhibiting inductance decreasing rapidly from 2.5A up.

As explained above, the test results successfully proved that the example wire-wound inductors according to the present invention using polygonal column cores exhibited the DC bias characteristics which were superior to those of the wire-wound inductors using sintered ferrite cores.

### INDUSTRIAL APPLICABILITY

The present invention relates to a wire-wound inductor for use in a power source circuit etc. included in micro electronic devices e.g. mobile phones and computers etc.

1. A wire-wound inductor comprising:
a wire-wound inductor core made of a pressed body obtained by compression-molding mixed magnetic material powder including binder, the wire-wound inductor core having a groove section formed therearound by machining and grinding; and
a metal conductive wire wound around the groove section of the wire-wound inductor core, wherein
the magnetic substance powder has content ratio of 4 to 13 wt % of Si, 4 to 7 wt % of Al, the balance Fe, and unavoidable impurity, and
the magnetic substance powder has particle diameter distribution in which equal to or greater than 90% of the magnetic substance powder has particle diameter equal to or lower than 75 μm.

2. (canceled)

3. A wire-wound inductor comprising:
a wire-wound inductor core made of a pressed body obtained by compression-molding mixed magnetic material powder including binder, the wire-wound inductor core having a groove section formed therearound machining grinding; and
a metal conductive wire wound around the groove section of the wire-wound inductor core, wherein
the magnetic substance powder has content ratio of 4 to 8 wt % of Si, the balance Fe, and unavoidable impurity, and
the magnetic substance powder has particle diameter distribution in which equal to or greater than 80% of the magnetic substance powder has particle diameter equal to or lower than 45 μ.

4. The wire-wound inductor as claimed in claim 1, wherein the wire-wound inductor core has a round column shape or a polygonal column shape.

5. The wire-wound inductor as claimed in claim 1, wherein the groove section formed on the wire-wound inductor core has a depth which is equal to or lower than ⅔ of a width of the wire-wound inductor core.

6. The wire-wound inductor as claimed in claim 1, wherein the magnetic substance powder is obtained by metal comminution or atomization.

7. The wire-wound inductor as claimed in claim 1, wherein the binder is added by equal to or lower than 5 wt %.

8. A method for manufacturing a wire-wound inductor comprising the steps of:
manufacturing a wire-wound inductor core; and
winding a metal conductive wire around the wire-wound inductor core, wherein
the step of manufacturing the wire-wound inductor core includes:
manufacturing the magnetic substance powder having content ratio of 4 to 13 wt % of Si, 4 to 7 wt % of Al, the balance Fe, and unavoidable impurity;
limiting particle diameter of the magnetic substance powder;
adding binder to the magnetic substance powder;
compressing the magnetic substance powder, to which the binder was added, to form a pressed body; and
grinding the pressed body by machine, and wherein
in the step for limiting the particle diameter, the magnetic substance powder has particle diameter distribution in which equal to or greater than 90% of the magnetic substance powder is limited to particle diameter equal to or lower than 75 μm.

9. (canceled)

10. A method for manufacturing a wire-wound inductor comprising the steps of:
manufacturing a wire-wound inductor core; and
winding a metal conductive wire around the wire-wound inductor core, wherein
the step of manufacturing the wire-wound inductor core includes:
manufacturing the magnetic substance powder having content ratio of 4 to 8 wt % of Si, the balance Fe, and unavoidable impurity;
limiting particle diameter of the magnetic substance powder;
adding binder to the magnetic substance powder;
compressing the magnetic substance powder, to which the binder was added, to form a pressed body; and
grinding the pressed body by machine, and wherein
in the step for limiting the particle diameter, the magnetic substance powder has particle diameter distribution in which equal to or greater than 80% of the magnetic substance powder is limited to particle diameter equal to or greater than 45 μm.

11. The method as claimed in claim 8 for manufacturing the wire-wound inductor, wherein a shape of the pressed body formed in the compressing step is a round column shape or a polygonal column shape.

12. The method as claimed in claim 8 for manufacturing the wire-wound inductor, wherein in the grinding step, equal to or lower than ⅔ is ground with respect to the width of the pressed body.

13. The method as claimed in claim 8 for manufacturing the wire-wound inductor, wherein in the step for manufacturing the magnetic substance powder, the magnetic substance powder is manufactured by comminution of metal alloy or atomization of metal alloy.

14. The method as claimed in claim 8 for manufacturing the wire-wound inductor, wherein in the adding step, the binder is added by equal to or lower than 5 wt %.
